(19) United States
(12) Patent Application Publication
(10) Pub. No.: US 2026/0089019 A1
(43) Pub. Date: Mar. 26, 2026

(54) Decentralized On-Chain Publishing Platform and BEI Sovereign Semantic Ecosystem

(71) Applicant: FURONG BEI, SAN GABRIEL, CA (US)

(72) Inventor: FURONG BEI, SAN GABRIEL, CA (US)

(21) Appl. No.: 19/218,272

(22) Filed: May 25, 2025

(51) Int. Cl. H04L 9/00; G06F 21/62; G06N 5/022; H04L 9/32

(52) U.S. Cl. CPC H04L 9/50; G06F 21/6245; G06N 5/022; H04L 9/3213; H04L 9/3297; H04L 2209/56

(57) ABSTRACT

The present invention provides a fully automated, modular publishing platform that seamlessly integrates with content management systems (e.g., WordPress) to capture user-generated content—text, images, and rich metadata—and anchor it immutably onto the InterPlanetary File System (IPFS) and a blockchain registry. Each submission is packaged as structured JSON, streamed to an IPFS node, and its Content Identifier (CID) is recorded in a single atomic smart contract transaction. Beyond simple publication, the system maps every entry to a dynamically versioned “Ecological Module Dictionary” of 1,800+ semantic domains, correlates to 365 industry codes and 999 demand tags, and persists a BEI (Behavior-Economy-Identity) knowledge graph off-chain for multi-dimensional retrieval, DAO-based governance, and tokenized incentives (TimeCoin, BehaviorToken, IdentityCredit). The invention also supports subscription-based module licensing, OEM white-label deployments, and a developer marketplace, forming a sovereign, extensible ecosystem for global-scale, tamper-proof archival and sovereign content trade.

### 1. FIELD OF THE INVENTION

This invention relates to decentralized data recording and publication systems, particularly to a plugin-based publishing platform that enables individuals to render content in a CMS interface, automatically upload structured data and media to IPFS, and record an immutable content identifier on-chain, thus creating a sovereign historical ledger.

### 2. BACKGROUND OF THE INVENTION

Conventional web publishing relies on centralized servers, lacking true immutability and resilience. Prior art requires manual or complex wallet integrations for on-chain anchoring. There is a critical need for an end-to-end, user-friendly solution that:
Embeds within familiar CMS environments (e.g. WordPress),
Packages submissions as JSON with semantic metadata,
Automates IPFS and blockchain interactions,
Supports modular domain mapping, multi-dimensional retrieval, and commercial licensing.

### 3. SUMMARY OF THE INVENTION

The system comprises four layers:
1. Front-End CMS Plugin
   Shortcode/block [bei_publish_form] renders a customizable HTML form.
   Captures title, category (from 1,800+ modules), content, image files, timestamp, and optional DID wallet integration.
2. Backend Processor
   Hooks into CMS actions to sanitize inputs, create or update a Custom Post Type, and handle media via CMS APIs.
   Constructs JSON including: metadata arrays (modules, industry code, demand tags), timestamp, did, and media CIDs.
   Streams payload to IPFS HTTP API (/api/v0/add) and retrieves the CID.
3. Decentralized Storage & Blockchain Registry
   Uses a smart contract registry to record (CID, publish address, timestamp) in one atomic transaction.
   Returns CID and transaction hash for user confirmation with links to IPFS gateway and blockchain explorer.
4. Semantic Ecosystem & Licensing
   Off-chain Neo4j graph stores nodes and edges among Users, Publications, Modules, Industry Codes (365), Demand Tags (999).
   On-chain events emit lightweight indices for DAO governance and multi-dimensional query APIs.
   Supports subscription-based access to the module dictionary, OEM white-label deployments, and a developer marketplace with automated revenue-sharing.

### 4. BRIEF DESCRIPTION OF THE DRAWINGS

FIG. 1: End-to-end flow: CMS front-end→backend JSON packaging→IPFS upload→blockchain registry→user confirmation.

FIG. 2: BEI Semantic Knowledge Graph: nodes (User, Publication, Module, Industry, Demand) and labeled edges.

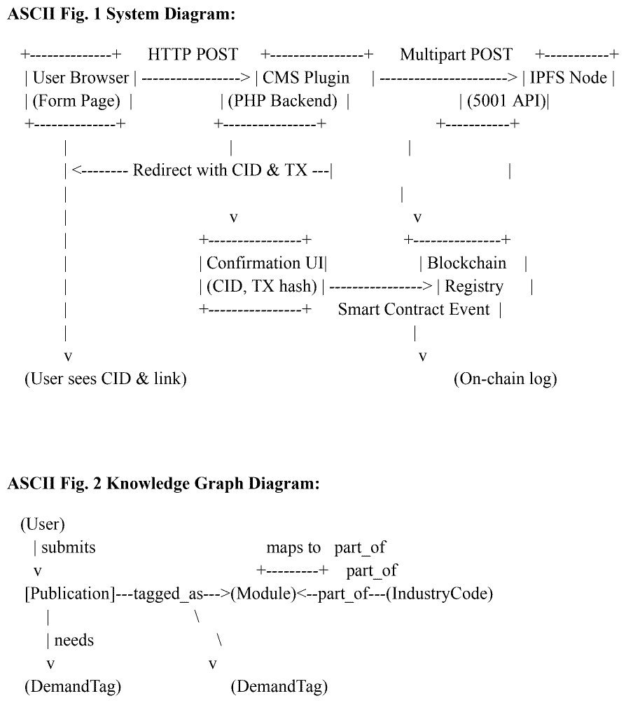

### 5. DETAILED DESCRIPTION

### 5.1 Front-End Integration

Shortcode: add_shortcode(‘bei_publish_form’,‘render_form’);
Fields: Title, Category dropdown, Content, File upload, hidden timestamp.
Submission: POST to admin-post.php?action=bei_ipfs_submit.

### 5.2 Backend Processing

Hooks: admin_post and admin_post_nopriv for bei_ipfs_submit.
Sanitization: sanitize_text_field, sanitize_texture_field, file type checks.
Post Creation: wp_insert_post( ), media_media_handle_upload( ).
JSON Payload: includes semantic arrays and metadata as shown above.

### 5.3 IPFS Upload

HTTP API: multipart POST to /api/v0/add for both JSON and media.
Response: parse Hash as CID.

### 5.4 Blockchain Registration

Contracts: RegistryContract, GraphIndexContract, TokenContract.
Transaction: registerContect(CID,publisher,timestamp) emits an event logged on-chain.

### 5.5 Semantic Mapping & Graph

Module Dictionary: modules.json with 1,800 entries, updated via API.
Mapping Engine: ML-based classification of text/images to modules.
Graph Database: Neo4j stores entities and relations.

### 5.6 Licensing & Commercial Models

1. Subscription APIs for module access.
2. OEM White-Label container deployments.
3. Developer Marketplace with revenue-share via smart contracts.

### 6. SYSTEM DIAGRAM

```
[User Browser]
  |
  | Submit form

[symbol]

[WordPress + Plugin] --> [PHP Processor]
```

| | |
|---|---|
| \| | \| |
| \| Render Success UI | \| JSON + media --> IPFS Node |
| [symbol] | [symbol] |
| [Confirmation UI] | [IPFS Gateway] |
| | \| |
| | [symbol] |
| | [Blockchain Registry] |
| | \| |
| | [symbol] |

[Semantic Graph DB & APIs]

1. A decentralized publishing system comprising:
a web-based front-end interface configured to receive user-submitted data including title, category, content, image, and timestamp;
a backend processing unit configured to sanitize and validate the submission and optionally upload media to local storage;
an IPFS interface that publishes the structured content onto IPFS and receives a content identifier (CID);
a success response module that displays the CID and redirects users to confirmation or archival pages.

2. The system of claim 1, wherein the timestamp is automatically generated in ISO 8601 format synchronized with the server's UTC time.

3. The system of claim 1, wherein the image upload is restricted to file types selected from the group consisting of: JPG, PNG, SVG, and WebP.

4. The system of claim 1, wherein the backend processing unit further comprises metadata normalization, tag standardization, and optional Web3 wallet verification.

5. The system of claim 1, further comprising a DAO-compatible token issuance module that rewards submission activity with utility tokens.

6. The system of claim 1, wherein IPFS uploading is performed via a local or remote IPFS HTTP API using endpoint /api/v0/add.

7. The system of claim 1, wherein published records are stored in a searchable WordPress Custom Post Type for on-site browsing and management.

8. A method for creating a sovereign on-chain publication comprising:
providing a publishing form rendered via a WordPress shortcode or block;
capturing input values and formatting them as structured JSON with semantic metadata;
transmitting the JSON payload to an IPFS node;
saving the resulting CID to an internal database;
displaying submission status and CID to the user.

9. The system of claim 1, wherein the user-submitted data further comprises structured sovereign metadata fields spanning seventeen taxonomic subdomains under the categories of Behavior, Economy, and Identity.

10. The system of claim 1, further integrated with a sovereign digital currency mechanism that tokenizes behavioral entries into TimeCoin, IdentityCredit, or DAO-based governance tokens.

11. The system of claim 1, when implemented with modular BEI domains, is extensible to connect to nine hundred ninety-nine types of human needs and three hundred sixty-five economic-industrial sectors.

12. The system of claim 1, forming the first sovereign decentralized calendar system for human behavior, economics, and identity starting from the BEI Genesis Year (1999), functioning as a civilization-grade time registry.

13. The system of claim 1, further comprising a semantic knowledge graph stored off-chain in a graph database and lightweight on-chain indices emitted via smart contract events, supporting multi-dimensional retrieval and DAO governance.

14. The system of claim 13, wherein the semantic knowledge graph connects publications to industry codes (365) and demand tags (999) through labeled relationships.

15. The system of claim 1, further comprising smart contract modules that automatically reward submissions with utility tokens selected from the group consisting of TimeCoin, BehaviorToken, and IdentityCredit.

16. The system of claim 1, further comprising subscription-based API licensing for third-party module integration and commercial usage.

17. The method of claim 8, wherein the smart contract transaction that records the CID, publisher address, and timestamp is submitted atomically without requiring the end user to operate a blockchain wallet.
